(19) United States
(12) Patent Application Publication
(10) Pub. No.: US 2017/0205024 A1
(43) Pub. Date: Jul. 20, 2017

(54) Multi-Functional Mounting Device

(71) Applicant: The Music People, Inc., Berlin, CT (US)

(72) Inventor: James R. Hennessey, West Hartford, CT (US)

(21) Appl. No.: 15/405,388

(22) Filed: Jan. 13, 2017

Related U.S. Application Data
(60) Provisional application No. 62/280,915, filed on Jan. 20, 2016.

(51) Int. Cl. F16M 11/16; H04R 1/08; F16B 2/06; F16M 13/02; F16M 11/06

(52) U.S. Cl. CPC F16M 11/16; F16M 13/022; F16M 11/06; F16B 2/065; H04R 1/08

(57) ABSTRACT

A mounting device includes a body defining a proximal end and a distal end and a mounting slot formed in the body proximate to the proximal end. The slot has a proximal side portion and a distal side portion, the slot including a curved bearing surface at the distal side portion. A clamping mechanism is received in the proximal end of the body, the clamping mechanism having a threaded shaft extending into the body at the proximal side portion of the slot, the threaded shaft configured to engage and press a bar against the curved bearing surface to releasably couple the mounting device on the bar. Multiple mounting posts are disposed at the distal end of the body, the mounting posts protruding from the body in different directions and being configured to connect an auxiliary object to the body and provide adjustment in position and orientation of the auxiliary object.

### TECHNICAL FIELD

The present teachings relate generally to an apparatus for supporting an object to a stand, such as a microphone stand, and more specifically a multi-functional mounting device that is attachable to the stand and provides multiple degrees of freedom in adjusting the orientation of an object connected to the mounting device.

### BACKGROUND

Conventional stands are typically designed with support structure to secure and hold only one object, such as a microphone in the context of a microphone stand or a music rest for holding sheets of music in the context of a music stand. One disadvantage of conventional stands is that they are not multi-functional and do not allow for one or more additional objects to be mounted to the shafts, posts, and/or arms of the stand.

Further, conventional systems for adjustably mounting and supporting various devices generally employ clamping mechanisms. Such clamping mechanisms generally mount and support the devices in a limited number of positions and orientations. Vibration or jarring of any portion of the system or the support device, however, may cause the clamping mechanism to loosen, thereby causing undesirable slippage and movement of the mounted device. In addition, sometimes such clamping devices inadequately grip whatever they are mounted to causing the device to slip.

### SUMMARY

The needs set forth herein as well as further and other needs and advantages are addressed by the present embodiments, which illustrate solutions and advantages described below.

An objective of the present teachings is to remedy the above problems associated with mounting devices for stands, such as a microphone stand. An objective of the present teachings is to provide a mounting device which adds versatility to an existing stand. For example, an objective of the present teachings is to provide a mounting device which enables one or more objects or components (e.g., microphone, audio recorder, camera, video camera, tablet, etc.) to be mounted to a stand along with the component which the stand was originally designed to hold. Another objective, for example, is to provide a mounting device which enables additional articulating arms, booms, and/or goosenecks to be mounted to a stand, the articulating arms, booms, and/or goosenecks being adapted to hold auxiliary objects or components.

The present teachings provide a mounting device configured for coupling to a tubing member of an existing support, wherein the mounting device includes a body defining a proximal end and a distal end and a mounting slot formed in the body proximate to the proximal end of the body. The mounting slot has a first proximal side portion and a second distal side portion. The mounting slot extends from a top surface to a bottom surface of the body and is adapted to receive the tubing member. The mounting slot comprises a curved bearing surface at the second distal side portion. A clamping mechanism is received in the proximal end of the body, wherein the clamping mechanism has a threaded shaft extending into the body at the first proximal side portion of the mounting slot. The threaded shaft is configured to engage and press a tubing member against the curved bearing surface to releasably couple the mounting device on the tubing member. The mounting device further comprises a plurality of mounting posts disposed at the distal end of the body, the mounting posts protruding from outer surfaces of the body in different directions, each mounting post being configured to connect an auxiliary object to the body and provide adjustment in position and orientation of the auxiliary object.

The present teachings also provide a mounting kit configured for coupling to a tubing member of an existing support. The mounting kit includes a mounting device having a body defining a proximal end and a distal end and a mounting slot formed in the body proximate to the proximal end of the body. The mounting slot has a first proximal side portion and a second distal side portion. The mounting slot extends from a top surface to a bottom surface of the body and is adapted to receive the tubing member. The mounting slot comprises a curved bearing surface at the second distal side portion. A clamping mechanism is received in the proximal end of the body, wherein the clamping mechanism has a threaded shaft extending into the body at the first proximal side portion of the mounting slot. The threaded shaft is configured to engage and press a tubing member against the curved bearing surface to releasably couple the mounting device on the tubing member. The mounting device further comprises a plurality of mounting posts disposed at the distal end of the body, the mounting posts protruding from outer surfaces of the body in different directions, each mounting post being configured to connect an auxiliary object to the body and provide adjustment in position and orientation of the auxiliary object. The mounting kit further includes one or more boom arms, articulating arms and/or goosenecks, which are releasably connected to the mounting posts at one end and are configured to releasably connect to an auxiliary object at another end.

Other features and aspects of the invention will become apparent from the following detailed description, taken in conjunction with the accompanying drawings, which illustrate by way of example, the features in accordance with embodiments of the invention. The summary is not intended to limit the scope of the invention, which is defined solely by the claims attached thereto.

### BRIEF DESCRIPTION OF THE DRAWINGS

FIG. 1A is a top view of a multi-functional mounting device in accordance with the present teachings.

FIG. 1B is an enlarged view of the multi-functional mounting device of FIG. 1A.

FIG. 2 is a rear, right side perspective view of the multi-functional mounting device of FIG. 1A affixed to a stand, such as a microphone stand.

FIG. 3 is a rear, left side perspective view of the multi-functional mounting device of FIG. 1A affixed to a stand, such as a microphone stand.

FIG. 4 is a depiction of the multi-functional mounting device of FIG. 1A which is affixed to a microphone stand and has three separate objects, such as two microphones with respective booms and a camera (e.g., video camera), connected thereto in different positions, angles and/or orientations.

It should be understood that throughout the drawings, corresponding reference numerals indicate like or corresponding parts and features.

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

The present teachings have been described in language more or less specific as to structural features. It is to be understood, however, that the present teachings are not limited to the specific features shown and described, since the devices herein disclosed comprise preferred forms of putting the present teachings into effect.

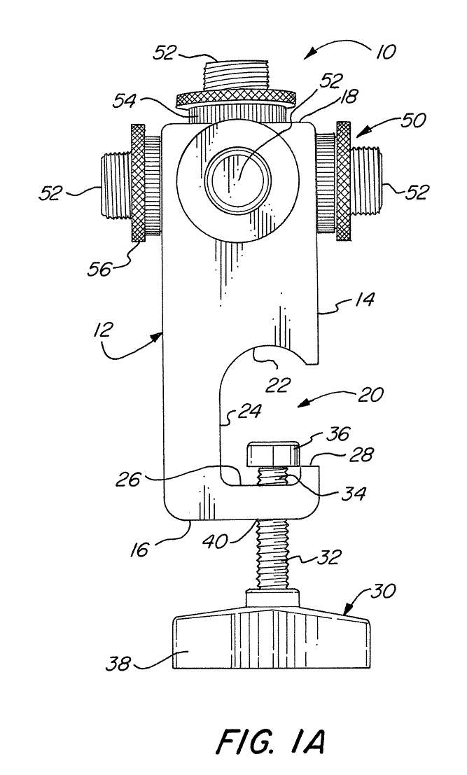

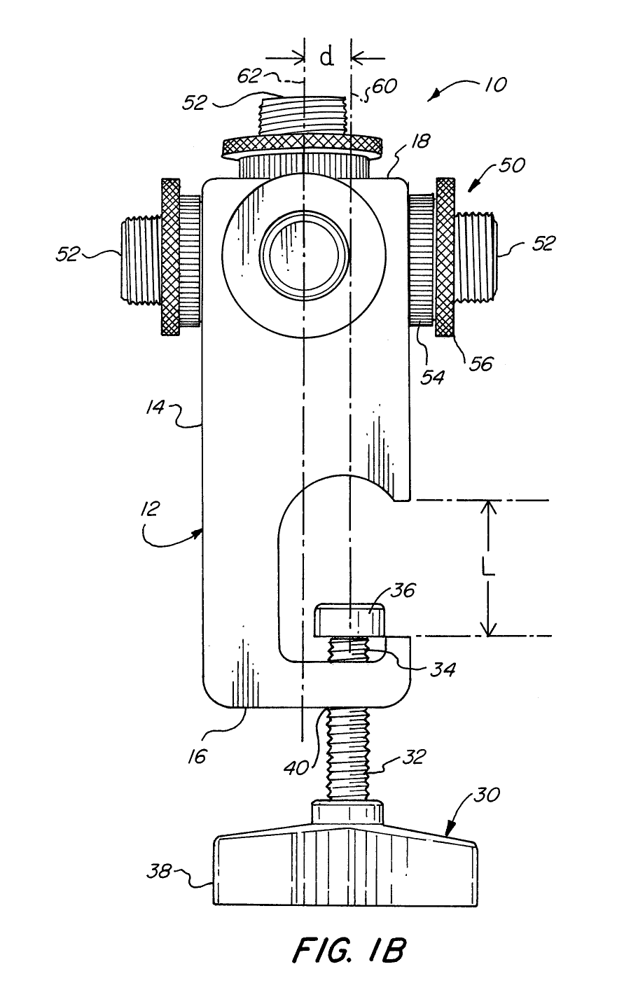

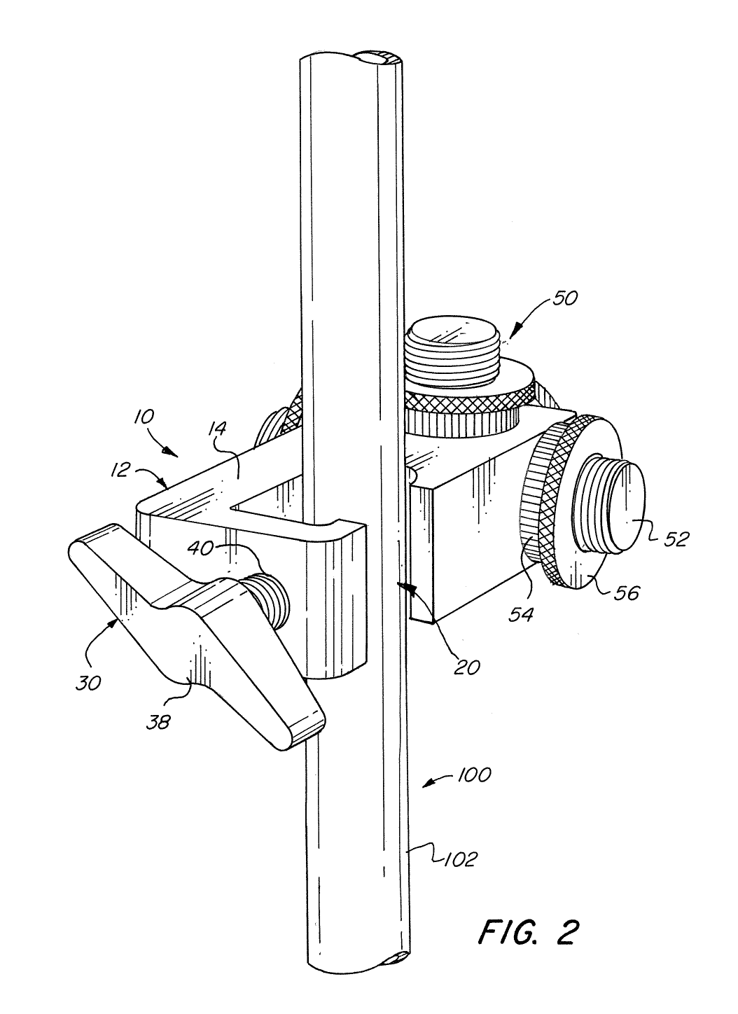

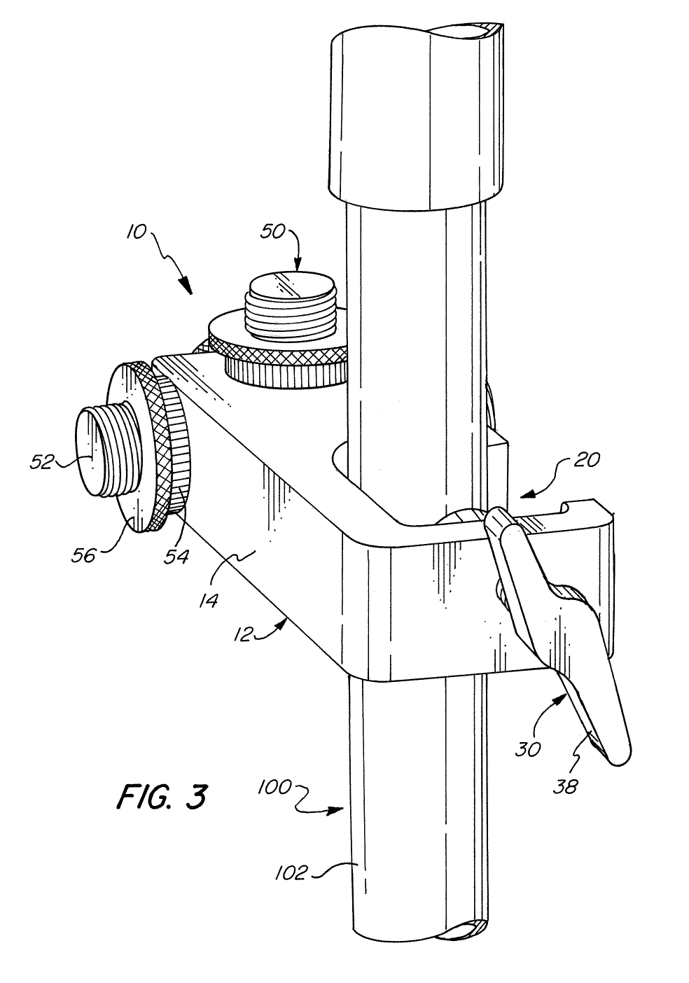

Referring to FIGS. 1A-1B and 2-3, the mounting device 10 includes a mounting bar 12 having a main body 14. The mounting bar 12 as shown is solid. In other embodiments, the mounting bar 12 may be hollow and thus have an inner border (interior wall) and an outer border (exterior wall). The hollow configuration of the mounting bar helps reduce the overall weight of the mounting device. It is noted, however, that the mounting bar in solid form is still lightweight. The main body 14 of the mounting bar, in some embodiments, defines a substantially rectangular outer surface in a cross sectional plane perpendicular to a longitudinal axis of the mounting bar (FIGS. 2-3). In other embodiments, the main body 14 may be configured with an elliptical or circular outer surface in the cross sectional plane perpendicular to the longitudinal axis. The main body 14 may be made of plastic or metal. In preferred embodiments, the main body has an aluminum or steel construction.

At a proximal end 16 of the mounting bar, the main body 14 defines a slot 20. However, the present teachings are not limited in this regard. The slot 20 can be located proximate to either the proximal end 16 or the distal end 18 or anywhere there between. As shown in FIGS. 1A-1B, the slot 20 is designed generally in the shape of a “C”. A distal portion 22 of the C-shaped configuration defines a curved (e.g., circular or elliptical) surface, while the center portion 24 of the configuration is substantially defined by a planar surface. In some cases, the center portion 24 has a curved (e.g., circular or elliptical) surface to provide improved or increased gripping contact with a round shaft/pole of the stand. The proximal portion 26 of the C-shaped slot 20 is defined by yet another planar surface that is substantially perpendicular to the planar surface of the center portion 24. The proximal portion 26 also includes a lip 28 at or near the opening of the slot 20. Although the slot 20 is described as having a C-shaped configuration, the present teachings are not limited in this regard. For example, the slot 20 may be designed with a U-shaped configuration.

The distal portion 22 has a curvature characterized by a first radius and defines the slot 20 such that the center point of the slot (see line 60 extending through the center point) is offset from a centerline 62 extending longitudinally through the mounting bar 12 by a distance “d” (FIG. 1B). The distal portion 22 defines the curved (e.g., circular or elliptical) surface which makes contact and mates with an item received in the slot 20, especially an item having a shape that complements the circular or elliptical surface. In offsetting the slot 20 by the distance “d”, a suitable amount of material remains on the body portion 14 in the area surrounding the slot 20 to enable the mounting device (and the auxiliary objects connected thereto) to be supported. The present invention, however, is not limited to the center point 60 of the slot being offset from the centerline 62 as shown in the figures, as other configurations are within the scope of the present teachings.

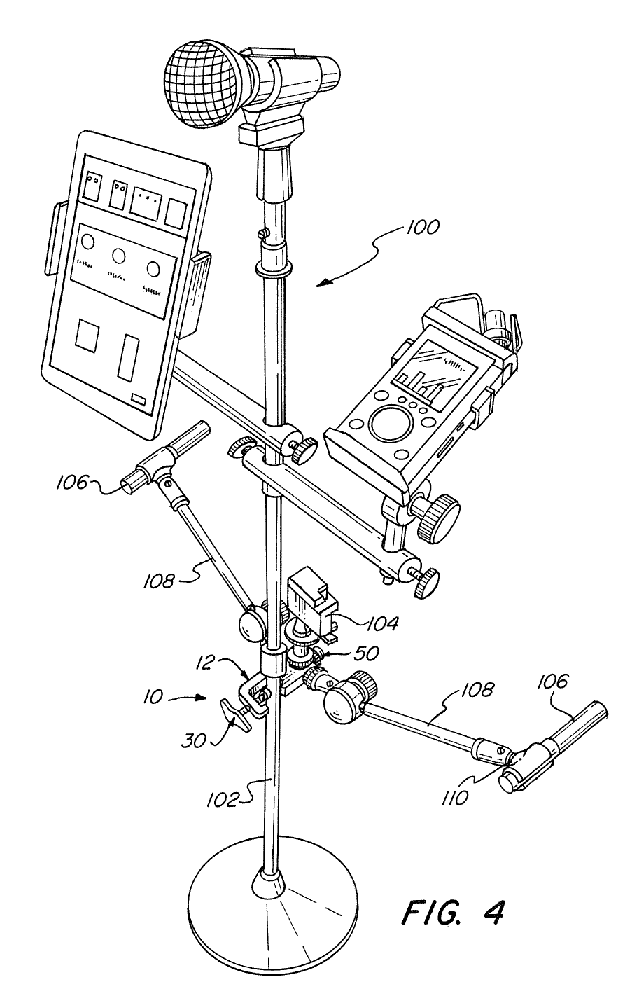

As shown in FIG. 4, the mounting bar 12 is configured to couple to an item, for example an existing support 100 having a part with a circular cross section. The mounting bar in general may be coupled to tubing, rods, or bars of the existing support 100. Examples of the existing support 100 includes, but is not limited to, a microphone stand, music stand, instrument stand (e.g., guitar stand), a legged stand, a boom arm, a desk, exercise equipment, tray table, or the like. In the embodiment shown in FIG. 4, the mounting bar 12 is affixed to a microphone stand 100 via the slot 20.

Referring back to FIGS. 1A-1B and 2-3, the mounting device 10 includes a clamping mechanism 30 to fasten securely and tightly together the mounting bar 12 and the existing support 100 to inhibit movement and/or separation. The clamping mechanism 30 includes a threaded shaft 32 with a threaded knob 38 disposed on a proximal end thereof. The threaded shaft 32 is inserted within and engaged with a threaded hole 40 extending through a proximal portion of the main body 14, and in particular through the proximal portion 26. To operate the clamping mechanism 30, the threaded shaft 32 is rotated about its longitudinal axis in one of two directions via the threaded knob 38. Rotation of the threaded knob in a first direction shifts a distal tip 34 of the threaded shaft through the proximal portion 26 of the mounting bar 12 into the slot 20. Upon further rotation of the threaded knob in the first direction, the distal tip 34 engages the existing support 100 (i.e., tubing, rods, or bars thereof) and further urges the existing support against the curved bearing surface of the distal portion 22. The existing support 100 is subsequently enveloped such that contact of the existing support with the curved bearing surface of the distal portion 22 holds the existing support in place. In some embodiments, the threaded knob 38 comprises an oversized thumbscrew and/or steel locking knob, both of which provide for a secure grip during mounting operations.

In order to release and detach the mounting device 10 from the existing support 100, the threaded knob 38 may be rotated in a second direction, which is opposite the first direction. When rotation in the second direction is performed, the distal tip 34 is retracted away from the existing support 100 and the distal portion 22 of the slot 20. As a result, the distal tip 34 ceases to apply inward pressure against the existing support 100, and the existing support can thereafter be removed from within the slot 20.

In some embodiments, the distal tip 34 of the threaded shaft has a pressure pad 36. The pressure pad 36 is configured to transmit and distribute evenly the inward pressure exerted by the clamping mechanism to the tubing, rod, or bar of the existing support 100 without causing physical damage (e.g., marring) to the existing support. The pressure pad prevents or at least reduces the likelihood of slipping between the existing support and the mounting device. The pressure pad 36 may be made of a rigid material. Alternatively, the pressure pad may be made of a flexible or elastic material (e.g. polypropylene) which can provide a cushion between the distal tip 34 and the existing support 100. FIGS. 1A-1B show the pressure pad 36 having a cylindrical (with circular cross section) shape with a planar contact surface that is adapted to engage the existing support 100. In other embodiments, the pressure pad 36 is a keyed pressure pad configured with a concave contact surface, which provides for increased stability between the mounting device and the existing support. The degree of curvature of the contact surface is set so that maximum surface contact is established between the pressure pad 36 and the tubing, rod, or bar of the existing support 100.

The threaded knob 38 is designed to have an ergonomic shape and provide comfortable rotation of the clamping mechanism 30 without causing undue stress or injury. For example, the threaded knob 38 is designed in an S-shape. Other shapes of the threaded knob, for example a diamond or rhombus shape, which promote minimal physical effort and/or discomfort and maximum efficiency are also covered by the present teachings.

Although the present invention is described by the use of a clamping mechanism having a threaded shaft and threaded knob, the present teachings are not limited in this respect. Other mechanisms such as a toggle clamp, a ball-detent, a spring-loaded handle, a spring-loaded piston, or the like, can also be used without departing from the broader aspects of the present teachings.

As described above, the curved bearing surface of the distal portion 22 of the slot is defined by a first radius. The size/value of the first radius, as well as a length “L” of the opening into the slot 20 is dependent on the size of the mounting bar and the size of the tubing, rod, or bar of the existing support that the mounting bar can be attached to. The first radius is sized and configured to accommodate an item having a cross-sectional dimension within a specific range and up to a particular diameter. For example, a first radius in the body portion 14 having a one-inch diameter may be sized and configured to receive a shaft or tube having a cross-sectional diameter of approximately 10-20 mm (0.4-0.8 inches.). A first radius having a larger diameter may be sized and configured to receive a shaft or tube having a larger cross-sectional diameter, for example 20-30 mm (0.8-1.18 inches) or 30-38 mm (1.18-1.50 inches). Further, the size of the curved bearing surface and thus the size of the mounting slot will define the overall size of the body of the mounting bar (e.g., thereby ensuring suitable amount of material remains on the body portion 14 in the area surrounding the slot 20 to enable stable support of the mounting device on the existing support 100). The present invention is not limited to the configuration as shown, however, as the slot could also be squared off to attach to a tray table, desktop, countertop or the like.

Still referring to FIGS. 1A-1B and 2-3, the distal end 18 of the mounting bar is configured with a plurality of mounting posts 50 protruding from the main body 14 for releasably connecting separate, auxiliary objects or equipment thereto. As shown in the figures for example, the mounting posts 50 are perpendicular relative to one another. The mounting posts 50 are configured to readily attach and detach the auxiliary object or equipment to the mounting bar and thus to the stand. In some embodiments, the mounting bar includes two mounting posts protruding out from the distal end 18 and disposed on any two of the top, bottom, left, right, front surfaces of the main body 14. For example, the two mounting posts may be located on the left and right surfaces and extend out along a line perpendicular to the longitudinal axis of the mounting bar. In other embodiments, the mounting bar includes three, four or five mounting posts. As shown in the figures, there are four mounting posts disposed on the distal end 18, extending from the top, left, right and front surfaces of the main body 14. The present teachings, however, are not limited to the particular configuration shown in the figures.

With the mounting posts extending from the distal end 18 in multiple directions (e.g., forward, up, down, left right), the mounting bar provides flexibility in positioning and orienting an auxiliary object or equipment from a point of origin along multiple degrees of freedom. For example, where the mounting bar includes four mounting posts (for example, in FIGS. 1A-1B), one auxiliary object can be selectively configured to attach to any one of the four posts, and as such the auxiliary object can be positioned generally in a forward direction (relative to the mounting bar), positioned generally off to the right of the mounting bar, positioned generally off to the left of the mounting bar, or positioned generally above the mounting bar. Further, each mounting post is configured to impart multiple degrees of freedom—including translation and rotation—with respect to the orientation and angle of the object connected thereto. For example, an auxiliary object, which comprises a boom arm and microphone and is connected to a mounting post, may be able to tilt forward and backward and/or swivel left and right and/or pivot side to side (FIG. 4). Moreover, the auxiliary object may be able to move up and down relative to the mounting bar and/or move left and right and/or move forward and backwards. This configuration of the mounting bar provides advantageously the capability of attaching an auxiliary object/equipment to an existing support with the flexibility to position, angle and orient the object/equipment relative to the existing support with different degrees of freedom.

Each mounting post comprises a threaded lug or threaded rod 52 protruding from the main body of the mounting bar. The threads of the lug 52 may extend partially along the length of the rod or alternatively, along the entire length of the rod from a proximal end to a distal end of the lug. In some embodiments, the lug 52 is integrally formed with the mounting bar, for example, being welded therefrom. In other embodiments, the lug 52 is threadedly fixed within a threaded hole at the distal end 18 of the mounting bar. Various means may be used to secure the proximal end of the lug 52 inside the main body 14. For example, a thread-locking fluid may be applied at the proximal end to form a bond between the surface of the lug and the complementary threads of the threaded hole. Alternatively, or in addition to the thread-locking fluid, a fastener, such as a threaded nut 54, may be screwed onto the threaded rod to a position between the proximal end and distal end of the lug, such that the nut abuts the outer surface of the mounting bar. In some embodiments, the threaded nut is a lock nut which resists loosening under vibrations and torque. In yet other embodiments, the threaded hole in the mounting bar for receiving the lug has a geometry that incorporates a spring along the length of the threaded hole. Upon the threaded lug 52 being screwed into the threaded hole, the spring clamps down and generates a prevailing torque during assembly and resists loosening.

As shown in the figures, the lug 52 has threads at its distal end. Accordingly, any auxiliary object, equipment or element suitably configured with receiving threads, including but not limited to a socket, can be coupled to the lug 52. In some embodiments, the lug 52 comprises a standard ⅝″-27 threaded stud.

The mounting posts 50 may also comprise a washer 56 disposed thereon adjacent to and distally relative to the fastener 52. The washer 56 serves as a spacer and helps to distribute the load derived from the auxiliary object or equipment connected to the distal end of the mounting post 50. In some embodiments, the washer 56 includes internal threads in order to be secured to the threaded lug 52 and maintain a relative position along the length of the lug. In other embodiments, the washer 56 is a locking washer which provide for auxiliary objects to mount precisely at a particular angle relative to the mounting bar.

FIG. 4 shows the multi-functional mounting device 10 in use. Specifically, the mounting bar 12 is affixed to the shaft or bar 102 via the clamping mechanism 30. An auxiliary object in the form of a camera 104 (e.g., still, video) is connected to the mounting post 50 disposed on the top surface of the mounting bar. This mounting post provides for the camera to swivel left and right. Further, two other auxiliary objects in the form of microphones 106 with corresponding boom arms (articulating arms, goosenecks, etc.) 108 are connected to the mounting posts 50 disposed on the left and right surfaces of the mounting bar. These two mounting posts provide for the microphone to be, for example, adjusted up and down and/or tilted forward and backwards. With the configuration shown in FIG. 4, the camera 104 is configured to record video of the audience, while the microphones 106 are configured to record audio of the audience.

In some embodiments, the present teachings provide for a mounting kit, which includes the multi-functional mounting device 10 and at least one boom arm (articulating arm, goosenecks, etc.) 108 that may be releasably attached in any configuration to one or more of the mounting posts 50 on the distal end of the mounting bar. The boom arm 108, at one end (i.e., proximal end) has a socket with threaded hole for connecting the boom arm to the mounting post 50. At the opposite end (i.e., distal end), the boom arm 108 has a clip for readily attaching an auxiliary object or equipment thereto. For example, the boom arm 108 may have a microphone clip 110 at its distal end for holding a microphone 106. In other embodiments, the boom 108 arm may have a tablet clip 112 to secure a tablet to the boom arm.

The boom arm may also be configured as an articulating boom arm. The boom arm, for example, may comprise multiple (e.g., two) shafts that may be bent/angled relative to one another (FIG. 4). In addition to the flexibility which the mounting device offers in adjusting the position and/or orientation of the attached object, the articulating boom arm further provides flexibility in positioning and orienting the object relative to the stand.

It should be understood to a person of ordinary skill in the art that different configurations of the mounting device are possible. For example, in some embodiments, the mounting device is affixed to a stand but has no objects connected thereto. In other embodiments, the mounting device affixed to the stand has any number between one and five objects connected to it. In one example, two audience microphones with respective booms and a video camera for recording the audience or the musician/singer may be attached to the microphone stand via the mounting device. Another exemplary configuration of the mounting device may be three video cameras connected to the mounting device, wherein the cameras in combination record a panoramic video of the audience.

Although the invention has been described with reference to a particular arrangement of parts, features and the like, these are not intended to exhaust all possible arrangements or features, and indeed many other modifications and variations will be ascertainable to those of skill in the art.

### LEGEND OF REFERENCE NUMERALS

10 multi-functional mounting device

12 mounting bar

14 main body of mounting bar

16 proximal end of main body

18 distal end of the main body

20 slot

22 distal portion of slot

24 center portion of slot

26 proximal portion of slot

28 lip at proximal portion of slot

30 clamping mechanism

32 threaded shaft

34 distal tip of threaded shaft

36 pressure pad at distal tip of threaded shaft

38 knob

40 threaded hole in proximal portion of mounting bar

50 mounting posts

52 threaded lug or threaded stud

54 threaded nut

56 washer

60 center point of slot

62 centerline of mounting bar

100 existing support (e.g., microphone stand)

102 shaft or bar of existing support

104 camera

106 microphone

108 boom arm

110 clip

112 tablet clip

d distance between center point of slot and centerline of the mounting bar

L length of opening into slot

What is claimed is:

1. A mounting device configured for coupling to a bar of an existing support, said mounting device comprising:
a body defining a proximal end and a distal end;
a mounting slot formed in the body proximate to the proximal end of the body, the mounting slot extending from a top surface to a bottom surface of the body for receiving the bar, the mounting slot having a first proximal side portion and a second distal side portion, the mounting slot comprising a curved bearing surface at the second distal side portion;
a clamping mechanism received in the proximal end of the body, the clamping mechanism including a threaded shaft extending into the body at the first proximal side portion of the mounting slot, the threaded shaft having a distal tip configured to engage and press the bar against the curved bearing surface to releasably couple the mounting device on the bar; and
a plurality of mounting posts disposed at the distal end of the body, said mounting posts protruding from outer surfaces of the body in different directions, each mounting post configured to connect an auxiliary object to the body and provide adjustment in position and orientation of the auxiliary object.

2. The mounting device of claim 1, wherein the mounting slot is C-shaped.

3. The mounting device of claim 1, wherein the mounting slot includes an opening formed in a side surface of the body, said opening having a size equal to or greater than the bar.

4. The mounting device of claim 3, wherein the mounting slot includes a center portion between the first proximal side portion and the second distal side portion and opposite the opening, the center portion having a substantially planar surface, and wherein the first proximal side portion has a substantially planar surface.

5. The mounting device of claim 4, wherein the first proximal side portion has a lip at the opening, the lip partially occluding the opening.

6. The mounting device of claim 1, wherein the curved bearing surface at the second distal side portion is defined by a radius with a center that is offset from a central axis of the body which extends longitudinally along the body.

7. The mounting device of claim 1, wherein the distal tip of threaded shaft has a pressure pad, the pressure pad being configured to distribute pressure exerted by the clamping mechanism onto the bar.

8. The mounting device of claim 7, wherein the pressure pad is made of a rigid material.

9. The mounting device of claim 7, wherein the pressure pad is made of an elastic material.

10. The mounting device of claim 7, wherein the pressure pad has a cylindrical shape with a planar contact surface adapted to engage the bar.

11. The mounting device of claim 7, wherein the pressure pad is a keyed pressure pad having a concave contact surface that is adapted to engage the bar.

12. The mounting device of claim 1, wherein each mounting post comprises a threaded stud configured to releasably connect the auxiliary object to the body.

13. The mounting device of claim 12, wherein the threaded stud is integrated with the body.

14. The mounting device of claim 12, wherein a proximal end of each threaded stud is fixed within a threaded hole that is formed in the distal end of the body.

15. The mounting device of claim 12, wherein each mounting post includes a threaded nut screwed onto the threaded stud such that the threaded nut abuts one of the outer surfaces of the body, the threaded nut locking the threaded stud with the body.

16. The mounting device of claim 1, wherein the body is hollow.

17. A mounting kit configured for coupling to a bar of an existing support, the mounting kit comprising:
a mounting device having:
a body defining a proximal end and a distal end;
a mounting slot formed in the body proximate to the proximal end of the body, the mounting slot extending from a top surface to a bottom surface of the body for receiving the bar, the mounting slot having a first proximal side portion and a second distal side portion, the mounting slot comprising a curved bearing surface at the second distal side portion;
a clamping mechanism received in the proximal end of the body, the clamping mechanism including a threaded shaft extending into the body at the first proximal side portion of the mounting slot, the threaded shaft having a distal tip configured to engage and press the bar against the curved bearing surface to releasably couple the mounting device on the bar; and
a plurality of mounting posts disposed at the distal end of the body, said mounting posts protruding from outer surfaces of the body in different directions, each mounting post configured to hold and secure an auxiliary object to the body and provide adjustment in position and orientation of the auxiliary object; and
at least one boom arm having one end configured to releasably connect to one of the mounting posts and another end for connecting to the auxiliary object.

18. The mounting kit of claim 17, wherein the at least one boom arm comprises two arms that articulate relative to one another.

19. The mounting kit of claim 17, wherein the at least one boom arm comprises a gooseneck.

20. The mounting kit of claim 17, wherein the mounting slot includes an opening formed in a side surface of the body, said opening having a size equal to or greater than the bar.

21. The mounting device of claim 17, wherein the curved bearing surface at the second distal side portion is defined by a radius with a center that is offset from a central axis of the body which extends longitudinally along the body.

22. The mounting device of claim 17, wherein the distal tip of threaded shaft has a pressure pad, the pressure pad being configured to distribute pressure exerted by the clamping mechanism onto the bar.

23. The mounting device of claim 17, wherein each mounting post comprises a threaded stud and a threaded nut screwed onto the threaded stud such that the threaded nut abuts one of the outer surfaces of the body, the threaded nut locking the threaded stud with the body.
